(19) United States
(12) Patent Application Publication
(10) Pub. No.: US 2015/0165695 A1
(43) Pub. Date: Jun. 18, 2015

(54) THREE DIMENSIONAL PRINTING APPARATUS

(71) Applicants: XYZprinting, Inc., New Taipei City (TW); Cal-Comp Electronics & Communications Company Limited, New Taipei City (TW); Kinpo Electronics, Inc., New Taipei City (TW)

(72) Inventors: Peng-Yang Chen, New Taipei City (TW); Wen-Ten Lin, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/225,451

(22) Filed: Mar. 26, 2014

(30) Foreign Application Priority Data
Dec. 13, 2013 (TW) 102146235

(51) Int. Cl. B29C 67/00; B29C 47/04

(52) U.S. Cl. CPC B29C 67/0096; B29C 67/0088; B29C 47/04; B33Y 30/00; B29K 2101/00

(57) ABSTRACT

A three-dimensional printing apparatus including a supporting platform, first tanks, an elevating platform disposed above the supporting platform, a light source module disposed corresponding to the elevating platform, and a control unit is provided. The first tanks are disposed on the supporting platform and filled with liquid forming materials respectively. After choosing one of the liquid forming materials, the control unit controls the supporting platform to move, in relative to the light source module and the elevating platform, till the chosen liquid forming material is moved to correspond to the light source module, so as to form a three-dimensional object through the chosen liquid forming material. Another three-dimensional printing apparatus is provided, in which a control unit controls the light source and the elevating platform to move to correspond to the chosen liquid forming material, so as to form a three-dimensional object through the chosen liquid forming material.

### CROSS-REFERENCE TO RELATED APPLICATION

This application claims the priority benefit of Taiwan application serial no. 102146235, filed on Dec. 13, 2013. The entirety of the above-mentioned patent application is hereby incorporated by reference herein and made a part of this specification.

### BACKGROUND OF THE INVENTION

1. Field of the Invention

The invention relates to a printing apparatus, and more particularly, to a three-dimensional printing apparatus.

2. Description of Related Art

With advancement of technologies, there are many different methods currently used to build physical three-dimensional (3D) models using additive manufacturing technology, such as building a model layer by layer. Generally, in the additive manufacturing technology, a design data of the 3D model, for example, built by computer-aided design (CAD) software or the like, is transformed into a plurality of thin (quasi-two-dimensional) cross-sectional layers stacked over one another in succession.

In the same time, many technical means for forming the thin cross-sectional layers are also provided. For example, a printing module of the three-dimensional printing apparatus is usually moved, with reference to space coordinates XYZ constructed from the design data of the 3D model, above a base in an XY plane to extrude or deposit a building material in correct shape of the cross-sectional layer. The building material being deposited may then be harden naturally or be cured by, for example, heating or irradiating with a light source, so as to form the desired cross-sectional layer. Therefore, by moving the printing module along a Z axis layer by layer, the cross-sectional layers may be gradually stacked along the Z axis, so that the building material may be cured layer by layer to form the 3D object.

Take a technique of forming the 3D object by curing the building material with the light source as an example, in which the three-dimensional printing apparatus may include a printing module adapted to be dipped into the building material in liquid state and a light source module irradiating the building material on the XY plane, so that the building material in liquid state may be cured and stacked on a platform of the printing module. Accordingly, the platform of the printing module may move along the Z axis layer by layer, so that the building material may be cured layer by layer to form the 3D object. However, in many existing three-dimensional printing technologies, the three-dimensional printing apparatus may be disposed with only one building material. Therefore, how to include more diversifications for the 3D object obtained from 3D printing, such as providing the 3D object with various colors, or constitute the 3D object by using various building materials with different material characteristics, has become one of major issues focused by persons skilled in the art.

### SUMMARY OF THE INVENTION

The invention is directed to a three-dimensional printing apparatus adapted to print the three-dimensional object with more diversifications.

The three-dimensional printing apparatus of the invention includes a supporting platform, a plurality of first tanks, an elevating platform, a light source module, and a control unit. The first tanks are disposed on the supporting platform and filled with a plurality of liquid forming materials respectively. The elevating platform is elevatably disposed above the supporting platform. The light source module is disposed corresponding to the elevating platform. The control unit is coupled to the light source module, the supporting platform and the elevating platform. After choosing one of the liquid forming materials, the control unit controls the supporting platform to move, in relative to the light source module and the elevating platform, till the chosen liquid foaming material is moved to correspond to the light source module, so as to form a three-dimensional object through the chosen liquid forming material.

In an embodiment of the invention, the supporting platform rotates on a plane, along an axial direction perpendicular to the plane, till the chosen liquid forming material is moved to correspond to the light source module.

In an embodiment of the invention, the supporting platform moves on a plane, along an axial direction parallel to the plane, till the chosen liquid forming material is moved to correspond to the light source module.

The three-dimensional printing apparatus of the invention includes a supporting platform, a plurality of first tanks, an elevating platform, a light source module, and a control unit. The first tanks are disposed on the supporting platform and filled with a plurality of liquid forming materials respectively. The elevating platform is elevatably disposed above the supporting platform. The light source module is disposed corresponding to the elevating platform. The control unit is coupled to the light source module and the elevating platform. After choosing one of the liquid forming materials, the control unit controls the light source module and the elevating platform to move, in relative to the supporting platform, to correspond to the chosen liquid forming material, so as to form a three-dimensional object through the chosen liquid forming material.

In an embodiment of the invention, the light source module and the elevating platform rotate along an axial direction for moving to correspond to the chosen liquid forming material, and the axial direction is perpendicular to a plane where the supporting platform is located.

In an embodiment of the invention, the light source module and the elevating platform move along an axial direction for moving to correspond to the chosen liquid forming material, and the axial direction is parallel to a plane where the supporting platform is located.

In an embodiment of the invention, an elevating path of the elevating platform is perpendicular to a plane where the supporting platform is located.

In an embodiment of the invention, the three-dimensional printing apparatus further includes a second tank disposed on the supporting platform and configured to be filled with a cleaning fluid. The elevating platform is adapted to be dipped into the cleaning fluid, so as to remove the liquid forming material which is not yet cured on the three-dimensional object.

In an embodiment of the invention, the light source module is disposed above the supporting platform. When the light source module irradiates the corresponding liquid forming material, the elevating platform moves in the corresponding liquid forming material towards a direction far away from the light source module, and gradually approaches a bottom portion of the corresponding first tank.

In an embodiment of the invention, the light source module is disposed under the supporting platform. When the light source module irradiates the corresponding liquid forming material, the elevating platform moves in the corresponding liquid forming material towards a direction far away from the light source module, and gradually approaches a top portion of the corresponding first tank.

In an embodiment of the invention, the control unit adjusts an operation parameter of the light source module according to the chosen liquid forming material.

In an embodiment of the invention, the liquid forming materials include a photosensitive resin.

In an embodiment of the invention, colors of the liquid forming materials are different from one another, so as to choose one of the liquid forming materials according to the colors of the liquid forming materials to correspond to the light source module.

Based on above, in a three-dimensional printing apparatus of the invention, the first tanks are disposed on the movable supporting platform, and the control unit controls the movable supporting platform to move, in relative to the light source module and the elevating platform, so as to move the chosen liquid forming material to correspond to the light source module. Or, in another three-dimensional printing apparatus of the invention, the first tanks are disposed on the stationary supporting platform, and the control unit controls the movable supporting platform and the movable elevating platform to move, in relative to the stationary supporting platform, so as to correspond to the chosen liquid forming material. Accordingly, the user may fill the first tanks with different liquid forming materials, and choose one among the liquid forming materials for printing, thereby adjusting a printing result of the three-dimensional object. As a result, the three-dimensional printing apparatus of the invention is adapted to print the three-dimensional object with more diversifications, and the user may choose the printing result of the three-dimensional object to be printed based on requirements.

To make the above features and advantages of the disclosure more comprehensible, several embodiments accompanied with drawings are described in detail as follows.

### BRIEF DESCRIPTION OF THE DRAWINGS

FIG. 1 is a three-dimensional schematic diagram of a three-dimensional printing apparatus according to an embodiment of the invention.

FIG. 2 is a schematic side view of the three-dimensional printing apparatus depicted in FIG. 1.

FIG. 3 is a schematic top view of the supporting platform depicted in FIG. 2.

FIG. 4 is a three-dimensional schematic diagram of a three-dimensional printing apparatus according to another embodiment of the invention.

FIG. 5 is a partially enlarged schematic diagram of the three-dimensional printing apparatus depicted in FIG. 2.

FIG. 6 is a partially enlarged schematic diagram of a three-dimensional printing apparatus according to another embodiment of the invention.

FIG. 7 is a three-dimensional schematic diagram of a three-dimensional printing apparatus according to an embodiment of the invention.

FIG. 8 is a schematic side view of the three-dimensional printing apparatus depicted in FIG. 7.

### DESCRIPTION OF THE EMBODIMENTS

It is to be understood that the foregoing and other detailed descriptions, features, and advantages are intended to be described more comprehensively by providing embodiments accompanied with figures hereinafter. In the following embodiments, wordings used to indicate directions, such as “up,” “down,” “front,” “back,” “left,” and “right”, merely refer to directions in the accompanying drawings. Therefore, the directional wording is used to illustrate rather than limit the invention. Further, in each of following embodiments, the same or similar reference numbers represent the same or similar elements.

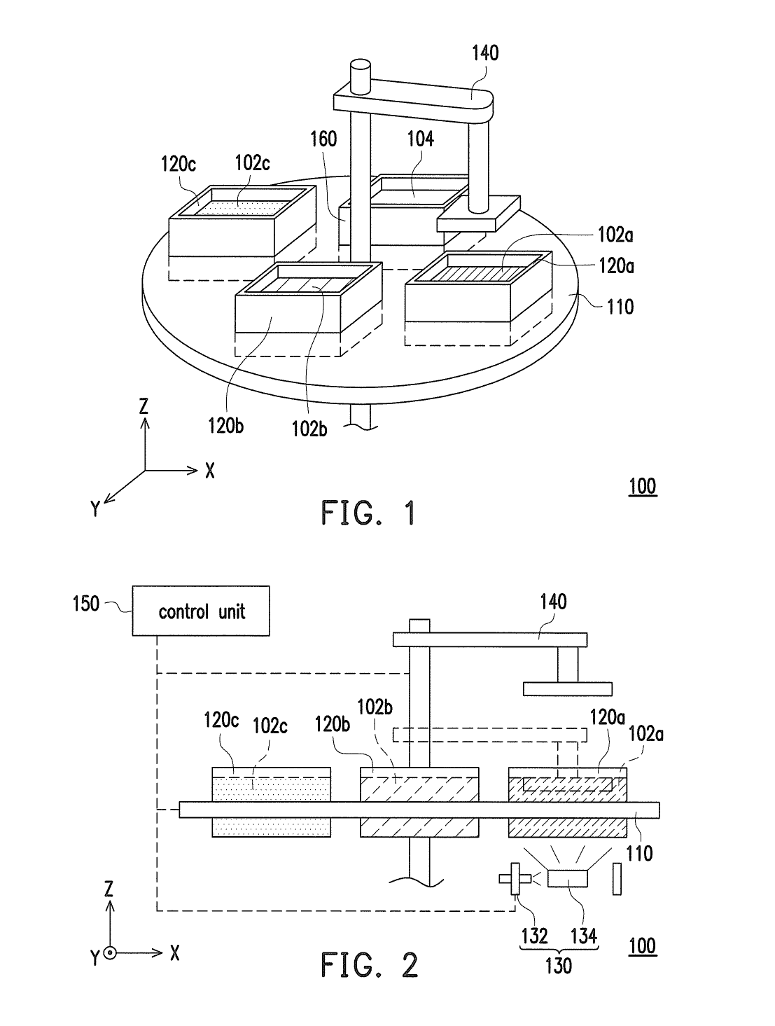

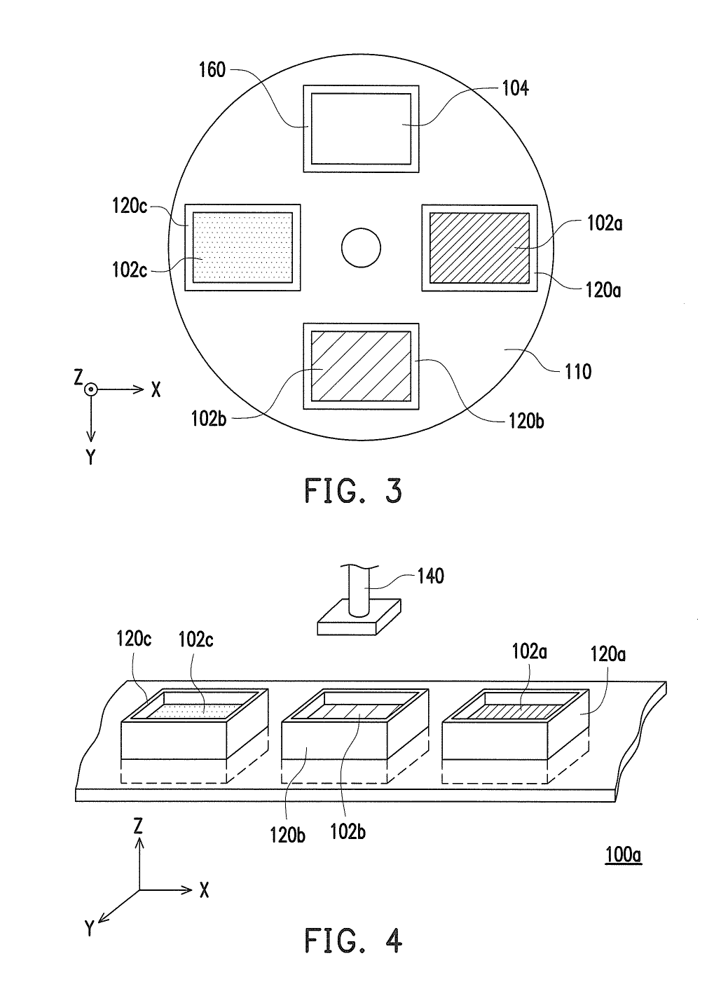

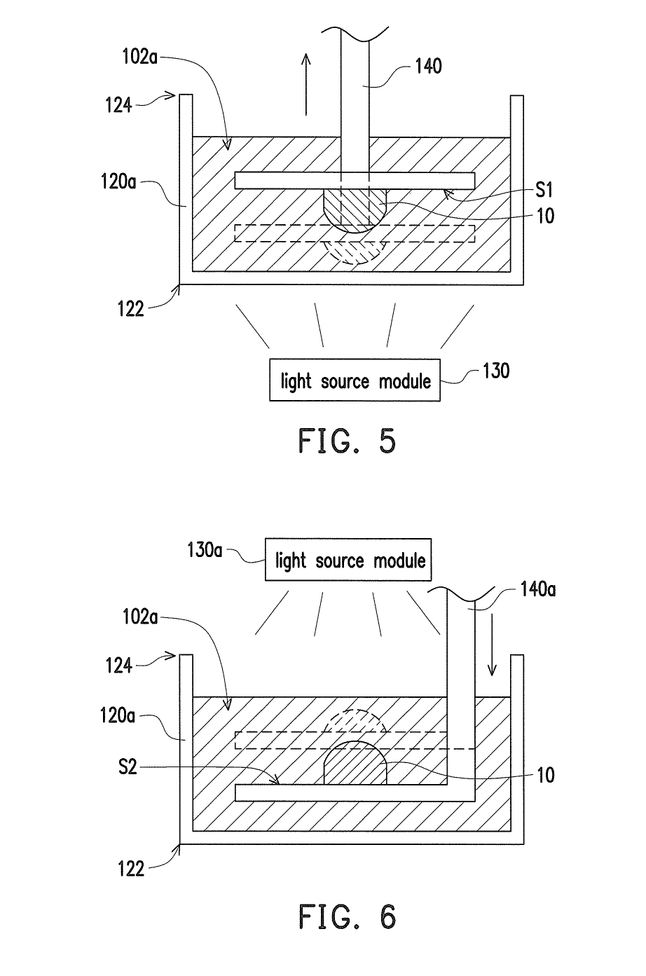

FIG. 1 is a three-dimensional schematic diagram of a three-dimensional printing apparatus according to an embodiment of the invention. FIG. 2 is a schematic side view of the three-dimensional printing apparatus depicted in FIG. 1. FIG. 3 is a schematic top view of the supporting platform depicted in FIG. 2. Referring to FIG. 1 and FIG. 3, in the present embodiment, a three-dimensional printing apparatus 100 includes a supporting platform 110, a plurality of first tanks 120a to 120c, a light source module 130, an elevating platform 140 and a control unit 150. The first tanks 120a to 120c are disposed on the supporting platform 110, and configured to be filled with a plurality of liquid forming materials 102a to 102c. The elevating platform 140 is elevatably disposed above the supporting platform 110, and the light source module 130 is disposed corresponding to the elevating platform 140. For instance, in the present embodiment, the light source 130 is disposed under the supporting platform 110. The control unit 150 is coupled to the light source module 130, the supporting platform 110 and the elevating platform 140, and configured to control the light source module 130, the supporting platform 110 and the elevating platform 140. The three-dimensional printing apparatus 100 is adapted to fabricate a three-dimensional object 10 (illustrated in FIG. 5) according to a digital three-dimensional model (not illustrated), in which the digital three-dimensional model may be built through, for example, a computer-aided design (CAD) or an animation modeling software, so as to crosscut the digital three-dimensional model into a plurality of cross-sectional layers. The three-dimensional printing apparatus 100 reads the digital three-dimensional model, and fabricates the three-dimensional object 10 according to the cross-sectional layers of the digital three-dimensional model. The three-dimensional object 10 is obtained from at least one of the liquid forming materials 102a to 102c which is cured after being irradiated by the light source module 130.

In the present embodiment, colors of the liquid forming materials 102a to 102c are different from one another. Therefore, according to the colors of the liquid forming materials 102a to 102c, a user may choose one of the liquid forming materials 102a to 102c (e.g., the liquid forming material 102a) for printing. When forming the three-dimensional object 10, the light source module 130 is required to correspond to the chosen liquid forming material (e.g., correspond to the liquid forming material 102a). Meanwhile, the elevating platform 140 being correspondingly disposed is also required to correspond to the chosen liquid forming material 102a. Accordingly, the elevating platform 140 may be dipped into and move in the liquid forming material 102a corresponding to the light source module 130 together with the light source module 130 irradiating the liquid forming material 102a at the same time, such that the three-dimensional object 10 may be formed through the liquid forming material 102a.

Further, in the present embodiment, the supporting platform 110 is a movable platform that is adapted to move in relative to the elevating platform 140 and the light source module 130. Therefore, after choosing one of the liquid forming materials 102a to 102c (e.g., the liquid forming material 102a) according to the colors of the liquid forming materials 102a to 102c, the control unit 150 may control the movable supporting platform 110 to move, in relative to the light source module 130 and the elevating platform 140, till the chosen liquid forming material 102a is moved to correspond to the light source module 130. In other words, the control unit 150 may control the movable supporting platform 110 to move, in relative to the light source module 130 and the elevating platform 140, so that one of the liquid forming materials 102a to 102c may be moved, based on user requirement, to correspond to the light source module 130, thereby adjusting a color of the three-dimensional object 10. However, in other embodiments, the liquid forming material may also be liquid forming materials with different material characteristics, and the invention is not limited thereto.

More specifically, referring to FIG. 1 to FIG. 3, in the present embodiment, the supporting platform 110 rotates on a plane, along an axial direction perpendicular to the plane, till the chosen liquid forming material 102a is moved to correspond to the light source module 130, and an elevating path of the elevating platform 140 is perpendicular to a plane where the supporting platform 110 is located. For instance, the supporting platform 110 may be, for example, a rotatable disk, and the first tanks 120a to 120c may be disposed on a circumference of the supporting platform 110. A plane where the rotatable disk (serving as the supporting platform 100) is located is an XY plane. The supporting platform 110 rotates on the XY plane, along a Z axis perpendicular to the XY plane, so that the chosen liquid forming material 102a is moved along the XY plane to correspond to the light source module 130. In contrast, the light source module 130 is fixed at a fixed position under the supporting platform 110. The elevating platform 140 is positioned above the supporting platform 110, and only capable of moving along the Z axis, thus the moving path (the Z axis) of the elevating platform 140 is perpendicular to the plane (the XY plane) where the supporting platform 110 is located. Accordingly, after the control unit 150 controls the supporting platform 110 to rotate on the XY plane along the Z axis so that the chosen liquid forming material 102a corresponds to the light source module 130, the control unit 150 may control the elevating platform 140 to move, along the Z axis towards the first tank 120a which is disposed on the supporting platform 110 and corresponding to the light source module 130, and to be dipped into the liquid forming material 102a filled in the first tanks 120a. In view of above, it can be known that in the present embodiment, before the supporting platform 110 moves the chosen liquid forming material 102a to correspond to the light source module 130 and the elevating platform 140, the light source module 130 and the elevating platform 140 are located on one fixed position, respectively. After the supporting platform 110 moves the liquid forming material 102a to correspond to the light source module 130 and the elevating platform 140, only the elevating platform 140 is dipped into or removed from the chosen liquid forming material 102a along the Z axis. Therefore, it can be known that the light source module 130 and the elevating platform 140 do not move along the XY plane. In other words, the light source module 130 and the elevating platform 140 are stationary on the XY plane. Therefore, in the three-dimensional printing apparatus 100 according to the present embodiment, the control unit 150 controls the supporting platform 110 to move, in relative to the light source module 130 and the elevating platform 140, till one of the liquid forming materials 102a to 102c (e.g., the liquid forming material 102a) disposed on the supporting platform 110 is moved together with movement of the supporting platform 110 to correspond to the light source module 130. Thereafter, since the light source module 130 is disposed corresponding to the elevating platform 140, the elevating platform 140 may also correspond to the chosen liquid forming material 102a at the same time without moving along the XY plane, and adapted to be dipped into and move in the chosen liquid forming material 102a at the subsequent forming steps. In other words, during the choosing stage of the three-dimensional printing apparatus 100 according to the present embodiment, the first tank 120a, 120b, or 120c is switched to correspond to the light source module 130 through the movement of the supporting platform 110, so that the elevating platform 140 may be dipped into the liquid forming material 102a, 102b, or 120c that corresponds to the light source module 130 in the forming stage. As a result, additional means for moving the light source module 130 and the elevating platform 140 along the XY plane is not required.

FIG. 4 is a three-dimensional schematic diagram of a three-dimensional printing apparatus according to another embodiment of the invention. Referring to FIG. 4, in the present embodiment, a three-dimensional printing apparatus 100a has structures and operation methods similar to that of the three-dimensional printing apparatus 100, and a major difference between the two is described below. In the present embodiment, the supporting platform 110 of the three-dimensional printing apparatus 100a is, for example, a conveyor belt. The supporting platform 110 moves on a plane where it is located (the XY plane), along an axial direction (an X axis) parallel to the plane, till the chosen liquid forming material 102a is moved to correspond to the light source module 130. In view of above, it can be known that a moving method for the supporting platform 110 is not particularly limited in the invention. An implementation of the supporting platform is not limited in the invention, as long as the supporting platform is capable of moving along the XY plane to selectively move one of the liquid forming materials 102a to 102c to correspond to the stationary light source module 130, thereby achieving the purpose of the invention in which the three-dimensional printing apparatus is capable of choosing the liquid forming materials 102a to 102c for forming based on requirements.

FIG. 5 is a partially enlarged schematic diagram of the three-dimensional printing apparatus depicted in FIG. 2. For clarity of the diagram, only the first tank 120a, the light source module 130 and part of the elevating platform 140 are illustrated in FIG. 5. Referring to FIG. 1, FIG. 2 and FIG. 5, in the present embodiment, the light source module 130 is disposed under the supporting platform 110. The elevating platform 140 includes a carrying surface S1, the three-dimensional object 10 is formed on the carrying surface S1, and the carrying surface S1 faces the light source module 130 as shown in FIG. 5. The control unit 150 is adapted to read the digital three-dimensional model, and choose one of the liquid forming materials 102a to 102c according to a color parameter of the digital three-dimensional model corresponding to the colors of the liquid forming materials 102a to 102c. For instance, after choosing one of the liquid forming materials 102a to 102c according to the colors of the liquid forming materials 102a to 102c, the control unit 150 may control the movable supporting platform 110 to move on the XY plane (e.g., by rotating through the rotatable disk of FIG. 1, or by moving through the conveyor belt of FIG. 4), till the chosen liquid forming material 102a is moved to correspond to the light source module 130 which is fixed on a fixed position. Thereafter, the control unit 150 controls a part of the elevating platform 140 (e.g., the control unit 51) to be dipped into the liquid forming material 102a, and to move in the liquid forming material 102a. At the time, the control unit 150 controls the light source module 130 to irradiate the chosen liquid forming material 102a, so as to cure the irradiated liquid forming material 102a layer by layer for forming the three-dimensional object 10 on the carrying surface S1 of the elevating platform 140.

More specifically, in the present embodiment, the light source unit 130 includes a laser component 132 and a galvano mirror component 134. The laser component 132 is adapted to emit a laser beam. The galvano mirror component 134 is adapted to project the laser beam onto the liquid forming material 102a corresponding to the light source module 130. A bottom portion 122 of the first tank 120a disposed on the supporting platform 110 is exposed outside the supporting platform 110, so that the light source module 130 may irradiate the liquid forming material 102a through the bottom portion 122 of the first tank 120a. In addition, the liquid aiming materials 102a to 102c may be, for example, photosensitive resins having different colors or other appropriate light curing materials. Accordingly, after the control unit 150 controls the part of the elevating platform 140 to be dipped into the liquid forming material 102a, the control unit 150 may control the elevating platform 140 to move in the liquid forming material 102a, and control the light source module 130 to irradiate the corresponding liquid forming material 102a. When the light source module 130 irradiates the corresponding liquid forming material 102a, the elevating platform 140 moves in the corresponding liquid forming material 102a towards a direction far away from the light source module 130, and gradually approaches a top portion 124 of the corresponding first tank 120a, as shown by an arrow in FIG. 5. Each time the elevating platform 140 moves to one specific position on the Z axis, the light source module 130 may irradiate a part of the liquid foaming material 102a located on the specific position for curing the same. Accordingly, as the elevating platform 140 moves layer by layer along the Z axis, on a traveling path thereof, the liquid forming material 102a may be cured layer by layer on the elevating platform 140, thereby forming the three-dimensional object 10 eventually.

FIG. 6 is a partially enlarged schematic diagram of a three-dimensional printing apparatus according to another embodiment of the invention. Referring to FIG. 6, in the present embodiment, a light source module 130a is disposed above the supporting platform 110. An elevating platform 140a is elevatably disposed above the supporting platform 110, and an elevating path thereof does not interfere the light source module 130a for irradiating the corresponding liquid forming material 102a. The elevating platform 140a includes a carrying surface S2, the three-dimensional object 10 is formed on the carrying surface S2, and the carrying surface S2 faces the light source module 130a as shown in FIG. 6. In the present embodiment, as similar to that in foregoing embodiments, after the movable supporting platform 110 moves the liquid forming material 102a to correspond to the light source module 130a, the control unit 150 (illustrated in FIG. 2) may control the carrying surface S2 of the elevating platform 140a to be dipped into the liquid forming material 102a, and to move in the liquid forming material 102a. Meanwhile, the control unit 150 controls the light source module 130a to irradiate the corresponding liquid forming material 102a. Moreover, when the light source module 130a irradiates the corresponding liquid forming material 102a, the elevating platform 140a moves in the corresponding liquid forming material 102a towards a direction far away from the light source module 130a, and gradually approaches a bottom portion 122 of the corresponding first tank 120a, as shown by an arrow in FIG. 6. Accordingly, as the elevating platform 140a moves layer by layer along the Z axis, on a traveling path thereof, the liquid forming material 102a may be cured layer by layer on the carrying surface S2 of the elevating platform 140a, thereby forming the three-dimensional object 10. In view of above, positions of the light source modules 130 and 130a are not particularly limited in the invention.

Referring back to FIG. 1, FIG. 2 and FIG. 5, in the present embodiment, besides that the three-dimensional printing apparatus 100 is capable of switching between the liquid forming materials 102a, 102b, or 102c corresponding to the light source module 130 by the supporting platform 100 moving on the XY plane, in relative to the light source module 130 and the elevating platform 140, to choose the colors of the three-dimensional object 100, the three-dimensional printing apparatus 100 is also capable of providing different colors to the three-dimensional object 10 to be printed, namely, the three-dimensional object 10 may include more than two colors. More specifically, when the three-dimensional object 10 to be printed includes multiple colors, based on foregoing embodiments, the three-dimensional object 100 may first form a part of the three-dimensional object 10 through the liquid forming material 102a, and the color of the part of the three-dimensional object 10 is corresponding to the color of the liquid forming material 102a. After the part of the three-dimensional object 10 having said color is completed, the control unit 150 may control the light source module 130 to stop irradiating the liquid forming material 102a, and control the elevating platform 140 to be removed from the first tank 120a.

Subsequently, the movable supporting platform 110 moves another one of the liquid forming materials 102a to 102c (e.g., the liquid forming material 102b) to correspond to the light source module 130. After the movable supporting platform 110 moves the liquid forming material 102b to correspond to the light source module 130, the control unit 150 may control the laser component 132 of the light source module 130 to adjust an operation parameter (e.g., adjust a power of the laser component 132) according to the corresponding liquid forming material 102b. Thereafter, the control unit 150 controls the elevating platform 140 to move in the liquid forming material 102b corresponding to the light source module 130, and controls the light source module 130 to irradiate the corresponding liquid forming material 102b, so as to cure the liquid forming material 102b being irradiated layer by layer on the part of the three-dimensional object 10 previously foamed, thereby forming another part of the three-dimensional object 10. Accordingly, in the three-dimensional printing apparatus 100 according to the present embodiment, the movable supporting platform 110 may switch choosing of the liquid forming materials 102a to 102c, such that the three-dimensional object 10 may be formed to include different colors by sequentially curing the liquid forming materials 102a and 102c having different colors.

In brief, in the three-dimensional printing apparatus 100 according to the present embodiment, because the first tanks 120a to 120c are correspondingly filled with the liquid forming materials 102a to 102c having different colors, the user may choose one of the liquid forming materials 102a to 102c according to the color on each part of the three-dimensional object 10 to be printed. Thereafter, before forming the three-dimensional object 10, the three-dimensional printing apparatus 100 may move the movable supporting platform 110 to selectively move the liquid forming material 102a, 102b, or 102c with the desired color to correspond to the light source 130 and the elevating platform 140. In addition, the control unit 150 may adjust the operation parameter of the laser component 132 according to the chosen liquid foaming material 102a, 102b, or 102c, so as to adjust curing times of the liquid forming materials 102a to 102c, or allow a structure formed by curing the liquid forming materials 102a to 102c to be more stable. Accordingly, the three-dimensional printing apparatus 100 of the invention is capable of repeatedly curing and stacking the liquid forming materials 102a to 102c having different colors till the three-dimensional object 10 includes the colors corresponding to that of the liquid forming materials 102a to 102c. Further, a color distribution for each part of the three-dimensional object 10 is determined by the operation parameter such as a sequence or the curing time for curing the liquid forming materials 102a to 102c on the elevating platform 140, and the operation parameter may be adjusted based on requirements.

Moreover, referring to FIG. 1 to FIG. 3, in the present embodiment, the three-dimensional printing apparatus 100 further includes a second tank 160 disposed on the supporting platform 110 and configured to be filled with a cleaning fluid 104. The elevating platform 140 is adapted to be dipped into the cleaning fluid 140, so as to remove the liquid forming material 102a, 102b, or 102c which is not yet cured on the three-dimensional object 10. More specifically, after each time the three-dimensional printing apparatus 100 forms a part of the three-dimensional object 10 by curing one of the liquid forming materials 102a to 102c (e.g., the liquid forming material 102a) and before the control unit 150 controls the elevating platform 140 to be dipped into another one of the liquid forming materials 102a to 102c (e.g., the liquid forming material 102b), the control unit 150 may control the elevating platform 140 to be dipped into the cleaning fluid 104 first, so as to remove the liquid forming material 102a which is not yet cured on the three-dimensional object 10. Accordingly, when the control unit 150 controls the elevating platform 140 to be dipped into the liquid forming material 102b, since there is no liquid forming material 102a left on the three-dimensional object 10, only the corresponding liquid forming material 102b is irradiated by the light source module 130. As a result, based on designs of the second tank 160 and the cleaning fluid 104, a problem of unexpected coloring on the parts of the three-dimensional object 10 due to a situation where the left liquid forming material 102a and the liquid forming material 102b are cured on the same part of the three-dimensional object 10 at the same time may be solved.

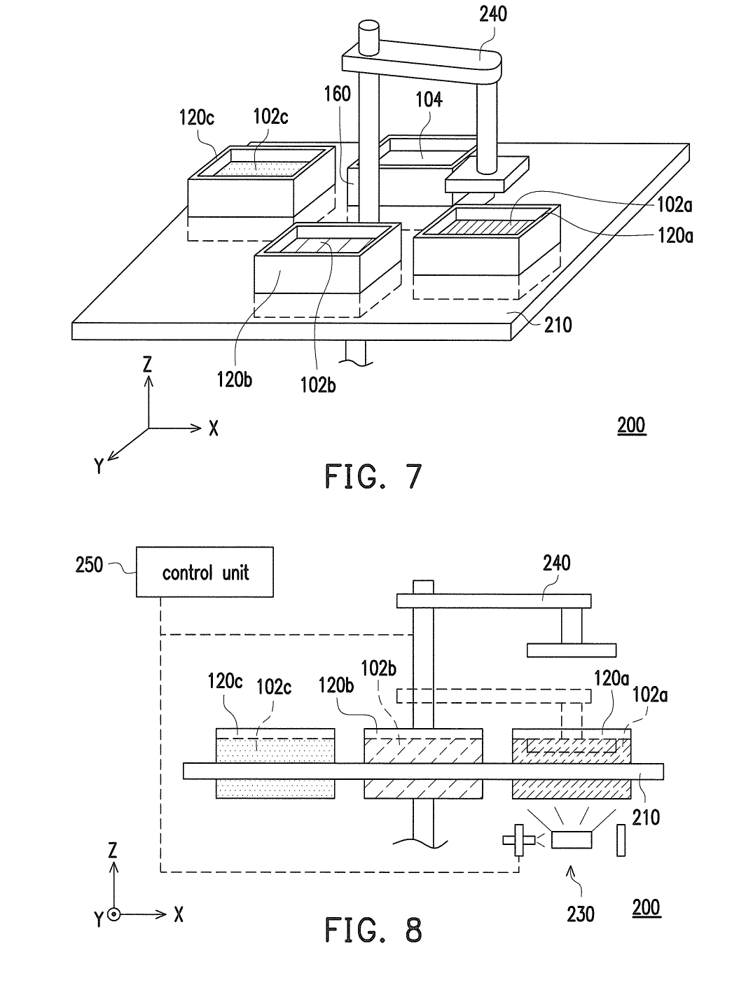

FIG. 7 is a three-dimensional schematic diagram of a three-dimensional printing apparatus according to an embodiment of the invention. FIG. 8 is a schematic side view of the three-dimensional printing apparatus depicted in FIG. 7. Referring to FIG. 7 and FIG. 8, in the present embodiment, a three-dimensional printing apparatus 200 has structures and operation concepts similar to that of above-said three-dimensional printing apparatus 100. Similarly, in the three-dimensional printing apparatus 200, the first tanks 120a to 120c are filled with the liquid forming materials 102a to 102c respectively, and one of the liquid forming materials 102a to 102c may be chosen base on user requirements. Detailed description there of may refer to the same in foregoing embodiments and is thus omitted hereinafter. Unlike foregoing embodiments, in the present embodiment, a supporting platform 210 of the three-dimensional printing apparatus 200 is a stationary platform located on the XY plane (e.g., a fixed platform). Therefore, it is not required for a control unit 250 of the present embodiment to control the stationary supporting platform 210. In contrast, the control unit 250 is coupled to a light source module 230 and an elevating platform 240, and the light source module 230 and the elevating platform 240 are both movable. For instance, the light source module 230 and the elevating platform 240 may both be disposed on a movable holder. Accordingly, the control unit 250 may control the light source module 230 and the elevating platform 240 to move in relative to the stationary supporting platform 210. In the present embodiment, the light source module 230 is disposed corresponding to the elevating platform 240, and located above or under the supporting platform 210 (e.g., similar to the light source module 130 in FIG. 5 or the light source module 130a in FIG. 6). The light source module 230 and the elevating platform 240 may include a fixing relation or linking-up relation for moving together, or may be moved in sequence under control of the control unit 250 respectively.

More specifically, in the present embodiment, the light source module 230 and the elevating platform 240 rotate along an axial direction (e.g., the Z axis) for moving to correspond to the chosen liquid forming material 102a, and the axial direction (the Z axis) is perpendicular to a plane (e.g., the XY plane) where the supporting platform 210 is located. Accordingly, after choosing one of the liquid forming materials 102a to 102c, the control unit 250 may control the movable light source module 230 and the movable elevating platform 240 to move on the XY plane, in relative to the stationary supporting platform 210, for example, rotating the holder connecting the light source module 230 and the elevating platform 240 along the Z axis). Accordingly, the movable light source module 230 may move to correspond to one of the liquid forming materials 102a to 102c (e.g., the liquid forming material 102a), and the movable elevating platform 240 may also move to correspond to the chosen liquid forming material 102a and adapted to be dipped into the liquid forming material 102a for moving in the subsequent steps. In other words, a major difference between the three-dimensional printing apparatus 200 and above-said three-dimensional printing apparatus 100 is that, the three-dimensional printing apparatus 200 is changed to be disposed with the movable light source module 230 and the movable elevating platform 240, so that the control unit 250 may control the movable light source module 230 to selectively move to correspond to the first tank 120a, 120b, or 120c, and control the movable elevating platform 240 to move to the chosen liquid forming material 102a, 102b, or 102c and to be dipped therein.

On the other hand, in an embodiment not illustrated, the supporting platform 210 may also be a platform in a strip-shape, so that the first tanks 110a to 110c may be arranged in sequence. In this case, the light source module 230 and the elevating platform 240 move along an axial direction (e.g., the X axis or the Y axis) for moving to correspond to the chosen liquid forming material 102a, and the axial direction (e.g., the X axis or the Y axis) is parallel to a plane (e.g., the XY plane) where the supporting platform 210 is located. In view of above, a moving method for the light source module 230 and the elevating platform 240 may be changed according to an arranging method of the first tanks 110a to 110c, and a shape of the supporting platform 210, the arranging method of the first tanks 110a to 110c, and the moving methods for the light source module 230 and the elevating platform 240 are not particularly limited in the invention.

Furthermore, in the present embodiment, the three-dimensional printing apparatus 200 is also capable of providing different colors to the three-dimensional object to be printed, namely, the three-dimensional object may include more than two colors. More specifically, after a part of the three-dimensional object 10 is formed by the three-dimensional printing apparatus 200 through the chosen liquid forming material 102a, the control unit 250 may control the light source module 230 to stop irradiating the liquid forming material 102a, and control the elevating platform 240 to be removed from the first tank 120a. After choosing another one of the liquid forming materials 102a to 102c (e.g., the liquid forming material 102b), the control unit 250 may control the movable light source 230 and the movable elevating platform 240 to move, in relative to the stationary supporting platform 210, to correspond to the chosen liquid forming material 102b, so that the liquid forming material 102b being irradiated may be cured layer by layer according above-said steps on the part of the three-dimensional object 10 previously formed, thereby forming another part of the three-dimensional object 10. Detailed description thereof may refer to the same in foregoing embodiments and is thus omitted hereinafter. Accordingly, in the three-dimensional printing apparatus 200 according to the present embodiment, the liquid forming materials 102a to 102c may be chosen by moving the movable light source module 130 and the movable elevating platform 140, such that the three-dimensional object may be formed to include different colors by sequentially curing the liquid forming materials 102a and 102c having different colors.

In brief, in the three-dimensional printing apparatus 200 having the first tanks 120a to 120c according to the present embodiment, because the first tanks 120a to 120c are correspondingly filled with the liquid forming materials 102a to 102c having different colors, the user may choose one of the liquid forming materials 102a to 102c according to the color on each part of the three-dimensional object to be printed. Thereafter, before foaming said part, the three-dimensional printing apparatus 200 may selectively move the movable light source module 230 and the movable elevating platform 240 to correspond to the liquid forming material 102a, 102b, or 102c with the desired color. In addition, the control unit 250 may adjust an operation parameter of the light source module 230 according to the chosen liquid forming material 102a, 102b, or 102c. Accordingly, the three-dimensional printing apparatus 200 of the invention is capable of repeatedly curing and stacking the liquid forming materials 102a to 102c having different colors till the three-dimensional object includes the colors corresponding to that of the liquid forming materials 102a to 102c.

Moreover, the three-dimensional printing apparatus 200 may also include the second tank 160 and the cleaning fluid 104 as the same to that of the three-dimensional printing apparatus 100. After each time the three-dimensional printing apparatus 200 forms a part of the three-dimensional object by curing one of the liquid forming materials 102a to 102c (e.g., the liquid forming material 102a), and before the control unit 250 controls the elevating platform 240 to be dipped into another one of the liquid forming materials 102a to 102c (e.g., the liquid forming material 102b), the control unit 250 may control the elevating platform 240 to be dipped into the cleaning fluid 104 first, so as to remove the liquid forming material 102a which is not yet cured on the three-dimensional object. As a result, based on designs of the second tank 160 and the cleaning fluid 104, a problem of unexpected coloring on the parts of the three-dimensional object 10 due to a situation where the left liquid forming material 102a and the liquid forming material 102b are cured on the same part of the three-dimensional object at the same time may be solved.

In view of the three-dimensional printing apparatuses 100 and 200, it can be known that the purpose of the invention is that, in the three-dimensional printing apparatus, the supporting platform is designed to be movable for choosing which of the liquid forming materials 102a to 102c is to correspond to the stationary light source module. Or, the light source module and the elevating platform may be designed to be movable for choosing which of the liquid forming materials 102a or 102c is to be corresponded. Despite that structures and operations of the two is not entirely the same, the same feature of choosing between the liquid forming materials 102a to 102c may both be provided. In other words, the purpose of forming the three-dimensional object 10 by choosing one of the liquid forming materials 102a to 102c may be achieved by adopting the design for the three-dimensional printing apparatus 100 in which the supporting platform 110 is movable on the XY plane, or adopting the design for the three-dimensional printing apparatus 200 in which the light source module 230 and the elevating platform 240 are movable on the XY plane. Therefore, in the three-dimensional printing apparatus of the invention, it is not required to design the supporting platform, the light source module and the elevating platform all to be movable on the XY plane, so that parts of means for moving said components as well as the steps for operating the three-dimensional printing apparatus may both be omitted moderately.

Nevertheless, in the three-dimensional printing apparatus of the invention, although the purpose of choosing the liquid forming materials 102a to 102c may be achieved as long as the supporting platform 110 is, or the light source module 130 and the elevating platform 140 are, movable on the XY plane, but the invention is not intended to limit that the supporting platform 110, the light source module 130 and the elevating platform 140 from all being movable at the same time. In other words, in another embodiment of the invention which is not illustrated, the supporting platform 110, the light source module 130 and the elevating platform 140 may also move in relative to one another, so that the user may use the control unit 150 to control movements of the supporting platform 110, the light source module 130 and the elevating platform 140 based on requirements, thereby choosing one of the liquid forming materials 102a to 102c (e.g., the liquid forming material 102a) to correspond to the light source module 130. In view of above, it can be known that a specific method for operating the supporting platform 110, the light source module 130 and the elevating platform 140 are not particularly limited in the invention, which may be adjusted based on requirements.

It should be noted that, despite that amounts of the first tanks 120a to 120c and the liquid forming materials 102a to 102c are illustrated as three for example, practically, the three-dimensional printing apparatus may adjust the amounts of the first tanks and the liquid forming materials disposed therein based on requirements. In addition, the operations regarding the components of the three-dimensional printing apparatuses 100, 100a and 200 in the space coordinates XYZ are only used for describing various embodiments of the invention instead of limiting the invention, so that the drawing may serve as reference to the text description.

In summary, in a three-dimensional printing apparatus of the invention, the first tanks are disposed on the movable supporting platform, and the control unit controls the movable supporting platform to move, in relative to the light source module and the elevating platform, so as to selectively move one of the liquid forming materials to correspond to the light source module. Or, in another three-dimensional printing apparatus of the invention, the first tanks are disposed on the stationary supporting platform, and the control unit controls the movable supporting platform and the movable elevating platform to move, in relative to the stationary supporting platform, so as to selectively correspond to one of the liquid forming materials. Accordingly, the user may fill the first tanks with different liquid forming materials, and choose one among the liquid foaming materials for printing, thereby adjusting a printing result of the three-dimensional object. Moreover, the three-dimensional printing apparatus may repeat said implementing steps, so that different liquid forming materials may be sequentially cured for forming parts of the three-dimensional object based on requirements, thereby providing the three-dimensional object with more diversifications. As a result, the three-dimensional printing apparatus of the invention is adapted to print the three-dimensional object with more diversifications, and the user may choose the printing result of the three-dimensional object to be printed based on requirements, so that the three-dimensional object printed by the three-dimensional printing apparatus may include more diversifications.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A three-dimensional printing apparatus, comprising:
a supporting platform;
a plurality of first tanks, disposed on the supporting platform and filled with a plurality of liquid forming materials respectively;
an elevating platform, elevatably disposed above the supporting platform;
a light source module, disposed corresponding to the elevating platform; and
a control unit, coupled to the light source module, the supporting platform and the elevating platform, wherein after choosing one of the liquid forming materials, the control unit controls the supporting platform to move, in relative to the light source module and the elevating platform, till the chosen liquid forming material is moved to correspond to the light source module, so as to form a three-dimensional object through the chosen liquid forming material.

2. The three-dimensional printing apparatus of claim 1, wherein the supporting platform rotates on a plane, along an axial direction perpendicular to the plane, till the chosen liquid forming material is moved to correspond to the light source module.

3. The three-dimensional printing apparatus of claim 1, wherein the supporting platform moves on a plane, along an axial direction parallel to the plane, till the chosen liquid forming material is moved to correspond to the light source module.

4. The three-dimensional printing apparatus of claim 1, wherein an elevating path of the elevating platform is perpendicular to a plane where the supporting platform is located.

5. The three-dimensional printing apparatus of claim 1, further comprising:
a second tank, disposed on the supporting platform, and configured to be filled with a cleaning fluid, wherein the elevating platform is adapted to be dipped into the cleaning fluid, so as to remove the liquid forming material which is not yet cured on the three-dimensional object.

6. The three-dimensional printing apparatus of claim 1, wherein the light source module is disposed above the supporting platform, and when the light source module irradiates the corresponding liquid forming material, the elevating platform moves in the corresponding liquid forming material towards a direction far away from the light source module, and gradually approaches a bottom portion of the corresponding first tank.

7. The three-dimensional printing apparatus of claim 1, wherein the light source module is disposed under the supporting platform, and when the light source module irradiates the corresponding liquid forming material, the elevating platform moves in the corresponding liquid forming material towards a direction far away from the light source module, and gradually approaches a top portion of the corresponding first tank.

8. The three-dimensional printing apparatus of claim 1, wherein the control unit adjusts an operation parameter of the light source module according to the chosen liquid forming material.

9. The three-dimensional printing apparatus of claim 1, wherein the liquid forming materials comprise a photosensitive resin.

10. The three-dimensional printing apparatus of claim 1, wherein colors of the liquid forming materials are different from one another, so as to choose one of the liquid forming materials according to the colors of the liquid forming materials to correspond to the light source module.

11. A three-dimensional printing apparatus, comprising:
a supporting platform;
a plurality of first tanks, disposed on the supporting platform and filled with a plurality of liquid forming materials respectively;
an elevating platform, elevatably disposed above the supporting platform;
a light source module, disposed corresponding to the elevating platform; and
a control unit, coupled to the light source module and the elevating platform, wherein after choosing one of the liquid forming materials, the control unit controls the light source module and the elevating platform to move, in relative to the supporting platform, to correspond to the chosen liquid forming material, so as to form a three-dimensional object through the chosen liquid forming material.

12. The three-dimensional printing apparatus of claim 11, wherein the light source module and the elevating platform rotate along an axial direction for moving to correspond to the chosen liquid forming material, and the axial direction is perpendicular to a plane where the supporting platform is located.

13. The three-dimensional printing apparatus of claim 11, wherein the light source module and the elevating platform move along an axial direction for moving to correspond to the chosen liquid forming material, and the axial direction is parallel to a plane where the supporting platform is located.

14. The three-dimensional printing apparatus of claim 11, wherein an elevating path of the elevating platform is perpendicular to a plane where the supporting platform is located.

15. The three-dimensional printing apparatus of claim 11, further comprising:
a second tank, disposed on the supporting platform, and configured to be filled with a cleaning fluid, wherein the elevating platform is adapted to be dipped into the cleaning fluid, so as to remove the liquid forming material which is not yet cured on the three-dimensional object.

16. The three-dimensional printing apparatus of claim 11, wherein the light source module is disposed above the supporting platform, and when the light source module irradiates the corresponding liquid forming material, the elevating platform moves in the corresponding liquid forming material towards a direction far away from the light source module, and gradually approaches a bottom portion of the corresponding first tank.

17. The three-dimensional printing apparatus of claim 11, wherein the light source module is disposed under the supporting platform, and when the light source module irradiates the corresponding liquid forming material, the elevating platform moves in the corresponding liquid forming material towards a direction far away from the light source module, and gradually approaches a top portion of the corresponding first tank.

18. The three-dimensional printing apparatus of claim 11, wherein the control unit adjusts an operation parameter of the light source module according to the chosen liquid forming material.

19. The three-dimensional printing apparatus of claim 11, wherein the liquid forming materials comprise a photosensitive resin.

20. The three-dimensional printing apparatus of claim 11, wherein colors of the liquid forming materials are different from one another, so as to choose one of the liquid forming materials according to the colors of the liquid forming materials to correspond to the light source module.
